(19) United States
(12) Patent Application Publication
(10) Pub. No.: US 2025/0086602 A1
(43) Pub. Date: Mar. 13, 2025

(54) AUTOMATED SAVINGS SYSTEM AND METHOD

(71) Applicant: New World Savings, Inc., Irvine, CA (US)

(72) Inventors: Scott Armstrong, Dana Point, CA (US); Ryan Armstrong, Encinitas, CA (US)

(73) Assignee: New World Savings, Inc., Irvine, CA (US)

(21) Appl. No.: 18/949,884

(22) Filed: Nov. 15, 2024

Related U.S. Application Data
(63) Continuation of application No. 17/726,601, filed on Apr. 22, 2022, now abandoned.
(60) Provisional application No. 63/179,031, filed on Apr. 23, 2021.

(51) Int. Cl. G06Q 20/10; G06Q 20/40; G06Q 40/02

(52) U.S. Cl. CPC G06Q 20/10; G06Q 20/405; G06Q 40/02

(57) ABSTRACT

A financial institution agnostic saving system including a server configured to (i) receive information for a funding source of a user at a first financial institution; (ii) receive information for a saving account of the user at a second financial institution; (iii) receive user saving target information for the user which includes a saving rule for determining when to transfer funds from the funding source to the saving account wherein the saving rule is defined based on an amount spent by the user; (iv) receive transaction information for a transaction by the user from a third financial institution, wherein the transaction information includes the amount spent by the user; and (v) transfer money from the funding source to the saving account according to the saving rule. The system may include a marketplace which allows users to modify user saving target information and/or make purchases with savings.

### REFERENCE TO THE RELATED PATENT APPLICATION

The present application claims benefit of U.S. Provisional App. No. 63/179,031 filed on Apr. 23, 2021.

### TECHNICAL FIELD

This disclosure relates to the field of saving methods based on purchases agnostic of financial institution and spending method.

### BACKGROUND

In a world where consumers are good at spending but struggle to save, often going into debt to pay for experiences and high value items, a financial institution and spending method agnostic micro-savings system tied to multiple spending tools with a custom goal-oriented savings solution is critical to helping consumers achieve financial independence and avoid undesired debt.

Personal savings and savings goals can be difficult to mechanize and achieve, especially when consumers (users) make purchases with multiple debit and/or credit cards. According to Experian, for example, one of the three major credit reporting agencies, the average American has four credit cards. Accordingly, it can be difficult to uniformly monitor, track and/or adjust savings goals based on purchases made across multiple payment platforms. For example, if a user makes a purchase with a credit card associated with a first financial institution, but pays the credit card bill with an account at a second financial institution it is difficult to track these purchases for savings purposes. The problem is even more difficult when the user makes purchases with multiple credit cards held by different financial institutions.

This is further complicated for automated systems which may require accessing the online services of multiple financial institutions and/or accounts, requiring different log in credentials. Plus, even if these individual financial institutions offered savings plans, then the savings plans would be incomplete, since they would only reflect purchasing activities in the control of the financial institution and would not reflect purchasing activities occurring external to the financial institution.

Accordingly, the present disclosure seeks to provide a technical improvement by providing an automatic savings system and method that is agnostic of the financial institution, provides transactional data to advertisers (Marketplace Partners), and allows a user to automate savings according to a savings rule, such as by purchase price percentage based savings (e.g., self-tipping), and is connected to an automated marketplace where users can utilize their savings to make purchases through a financial account connected to the savings platform, e.g., travel, events, fashion, footwear, auto, beauty partners, etc.

### SUMMARY

The present disclosure provides a financial institution and spending method agnostic system which utilizes a savings rule such as a purchase price percentage-based savings. The reflects a technical improvement over the art as it resolves the issues with saving, monitoring, and managing accounts across different platforms. The present disclosure also utilizes machine learning to calculate the percentage saving percentages to reach saving targets based on various factors including user spending habits, user saving limits, and aggregated data of other users. This includes providing automated saving adjustment suggestions as well as calculating individual and daily suggestions to protect against low balances and overdrafts.

The present disclosure further comprises an integration of a marketplace which allows users to invest or purchase with their savings

According to one embodiment, a financial institution agnostic saving system includes a server configured to (i) receive information for a funding source of a user at a first financial institution; (ii) receive information for a saving account of the user at a second financial institution; (iii) receive user saving target information for the user wherein the user saving target information comprises a saving rule for determining when to transfer funds from the funding source to the saving account wherein the saving rule is defined based on an amount spent by the user; (iv) receive transaction information for a transaction by the user from a third financial institution, wherein the transaction information includes the amount spent by the user; and (v) transfer money from the funding source to the saving account according to the saving rule based on the transaction information.

The server may be configured to determine whether to suggest a modification to the user saving target information, and the user saving target information may comprise a savings goal and a target date.

The server may be configured to (i) generate a user profile of the user wherein the user profile comprises a spending history; (ii) calculate a target goal achievement date based on the savings goal, the savings rule, and the user profile; and (iii) determine whether to suggest a modification to the user saving target information based on the target goal achievement.

If the target date predates the target goal achievement date, the server may be configured to modify the saving rule such that, based on the spending history, the user will achieve the saving goal on or before the target date

The saving system may include a marketplace. The server may be configured to (i) obtain marketplace information from the marketplace; and (ii) determine whether to suggest a modification to the user saving target information based on the marketplace information. The marketplace information could include information relating to user saving target information of other users. The saving target information may include a savings goal and the marketplace information may include information related to the savings goal. The saving target information may include a target date and the marketplace information may include information related to the target date.

The determination may be based on the target goal achievement date, aggregated user data, and marketplace information.

The suggested modification may be based on an artificial intelligence model utilizing (i) the user profile and aggregated user data based on activity of other user, and/or (ii) the user profile and marketplace information.

The user profile may be generated using an artificial intelligence model utilizing the user profile and aggregated user data based on activity of other users

The server may be configured to implement suggested modifications and then update the saving target information.

The server may be configured to obtain new transaction information and update the user profile after determining whether to suggest a modification.

According to another embodiment, a financial institution agnostic saving method includes (i) receiving information for a funding source of a user at a first financial institution; (ii) receiving information for a saving account of the user at a second financial institution; (iii) receiving user saving target information for the user wherein the user saving target information includes a saving rule for determining when to transfer funds from the funding source to the saving account wherein the saving rule is defined based on an amount spent by the user; (iv) receiving transaction information for a transaction by the user from a third financial institution, wherein the transaction information includes the amount spent by the user; and (iv) transferring money from the funding source to the saving account according to the saving rule based on the transaction information.

According to another embodiment, a non-transitory computer readable storage medium storing a plurality of instructions, wherein when executed by at least one processor, the plurality of instructions cause a computer to (i) receive information for a funding source of a user at a first financial institution; (ii) receive information for a saving account of the user at a second financial institution; (iii) receive user saving target information for the user wherein the user saving target information includes a saving rule for determining when to transfer funds from the funding source to the saving account wherein the saving rule is defined based on an amount spent by the user; (iv) receive transaction information for a transaction by the user from a third financial institution, wherein the transaction information includes the amount spent by the user; and (v) transfer money from the funding source to the saving account according to the saving rule based on the transaction information.

### BRIEF DESCRIPTION OF DRAWINGS

The present disclosure is illustrated by way of example and not limited in the figures of the accompanying drawings in which like references indicate similar elements.

FIG. 1 depicts a flow chart of an embodiment of the disclosure.

FIG. 2 depicts exemplary components for a system which may be utilized according to certain embodiments of the disclosure.

FIG. 3 depicts a flow chart of an intelligent saving system according to an embodiment of the disclosure.

FIG. 4 depicts a flow chart of an intelligent saving system further including marketplace information according to an embodiment of the disclosure.

FIG. 5 depicts a flow chart of the logic for a determination whether to suggest a saving modification according to an embodiment of the disclosure.

### DETAILED DESCRIPTION

The following detailed description is provided with reference to the figures. All identically numbered reference characters correspond to each other so that a duplicative description of each reference character in the drawings may be omitted. Exemplary embodiments are described to illustrate the disclosure, not to limit its scope, which is defined by the claims. Those of ordinary skill in the art will recognize a number of equivalent variations in the description that follows without departing from the scope and spirit of the disclosure.

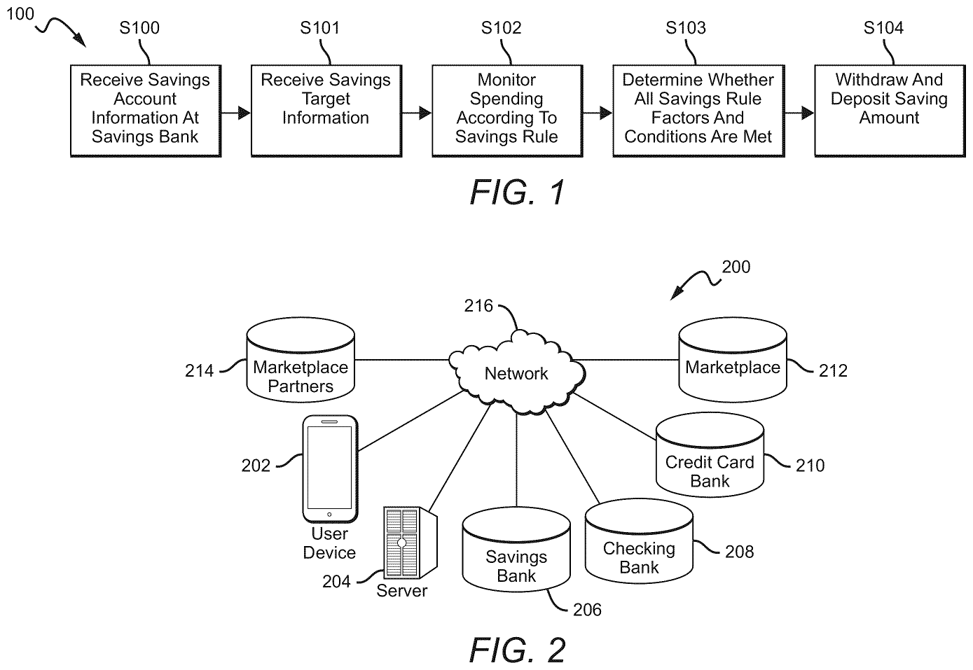

FIG. 1 shows a method 100 implemented by a Saving System 200 (or System) for automatically depositing money to achieve a Savings Goal based on a value of goods and services purchased by a user applied to a user saving rules. While FIG. 1 includes various steps in a certain order, it is understood that certain of these steps may not be required, that the order of steps may change, and/or that other intervening steps may be utilized depending on the system and user requirements and desires.

In certain embodiments, S100 a user enrolls/registers with a Savings System and the establishes a user account (“Savings Account”) at a financial institution (“Savings Bank.”). The Savings Account could also be established separately by the user or via a variety of methods such as an automated service through the Savings System or through a third party intermediary.

The Savings Bank could be a brick-and-mortar bank, online bank, credit union, investment institution, financial technology company (crypto wallet), or any other institution where a user has an account that the Saving System 200 or user can direct funds.

During the enrollment phase, the user enters certain personal profile information such as name, email, and/or phone number, login and password information, and Funding Source information into the Savings System 200.

The Funding Source may be a savings account, checking account, money market account, crypto wallet, or other account to which the user can direct funds. The Funding Source may be verified by the Saving System 200 (via the Saving System itself or third party) and synched so that the Funding Source is connected to the Saving System 200 and enables transfer of funds to and from the Savings Bank and Savings Account.

In step S101 the user sets a Savings Plan in the form of Savings Target Information which may include, for example, a Savings Goal (e.g., an amount of saving or Savings Target such as a purchase objective such as a down payment on a car), Savings Target Date (e.g., date to reach Savings Goal) and a Savings Rule with the Savings System.

Although this disclosure describes embodiments involving one user, it is known that the Savings System 200 is configurable such that multiple users can set a Group Savings Plan including the Savings Information discussed above with the Savings Systems. For example, the group may want to purchase a new set of equipment for a band, collect a desired amount for a field trip, or donate a certain amount to a charity. The group can be restricted, e.g., five members of a band or second grade class, or unrestricted, e.g., anybody who wants to donate to a certain charity.

The Savings Goal may be an amount of money that the user would like to save by the Target Date or during a target amount of time, e.g., $10,000 over 3 months. The Savings Goal can be independently defined by a user (custom goal), selected from a set of predefined goals (popular goals), or, as discussed below, computer developed suggestions that may be derived from an Artificial Intelligence engine. For example, the Saving Goals may be based on a user desire to save 10% of total spend; comparable Users are saving 15% towards Christmas presents; other comparable Users are saving towards the new electronic device coming to market in April, or other user saving target information. As will be discussed below, this information also be used for modification suggestions.

The present system is also configured to provide guidance or Modification Suggestions to adjust the User Saving Target Information such as by using Artificial Intelligence. “Artificial Intelligence” is used in the present disclosure within the context of its broadest definition. The capability of a machine to imitate intelligent human behavior. For example, the Artificial Intelligence model may utilize a linear regression model, deep neural network, logistic regression, decision tree, linear discriminant analysis, K-nearest neighbors, or other models as would be understood by one of skill in the art.

The Savings Goal may be, for example, a specific savings value, such as $10,000, or may be tied to other factors, such as certain percentages of earnings, spending habits or other Savings Targets such as specific promotions offered by the Savings System.

The Savings Goal may be associated with a specific purchasing objective (e.g. Savings Target), such as a 2021 Land Rover Range Rover or Disney World vacation. For example, a user may set the Savings Goal to be a down payment amount for use toward the purchase of a vehicle or admission tickets to Magic Kingdom and Epcot Center.

The Savings Goal may be associated with an event (e.g., rainy day, birthday, Christmas), category of goods or services (e.g., clothing, travel, vehicle, sports entertainment, technology, investments, etc), or combination thereof (e.g., travel for birthday, clothing for Christmas, etc.).

The user may have multiple Savings Goals, each with the same or different timelines and monetary objectives. The Saving System 200 may also enable the user to distribute or redistribute savings amounts between the multiple Savings Goals. For example, the user may have three different savings goals (events, travel, and technology), but decide to distribute in the following proportions: 46% to travel, 34% to technology and 20% to events.

The Saving System 200 may also be configured to share anonymized and/or aggregated Savings Goal data with outside parties, including Marketplace Partners 214 associated with the Savings System 200 through a Marketplace 212. Marketplace Partners 214, for example, would be able to target messages, inside or outside the Savings System, to the user or others similar users such as based on the User Profiles. The messages could be informational, banner ads, discounts, etc. As discussed below, the information from Marketplace Partners 214 and other Marketplace 212 information can be used to inform user Saving Information settings and/or integrated in the Artificial Intelligence Models such as to inform Intelligent suggestions and modifications.

In one embodiment, for example, a Marketplace Partner 214 could pay more (or bidding system designed for multiple Marketplace Partners 214 to participate) to have a more prominently displayed or optimized communication to a specific user or multiple user accounts.

In one embodiment, the Saving System 200 is configured to determine the user's location (e.g., based on user input or from user's device or mobile phone, via internet connection, mobile data connection, and/or GPS) and present target/location-based information and/or messages to the user based on the user's location and other information, including Savings Goals, aggregated user data (e.g., users with similar user profile), user demographics, time of day, etc.

As discussed below, the Savings Rule determines the amount of savings to be deposited into the Savings Account. As discussed below, the Savings Rule is initially calculated and/or set and then can be updated for example based on user adjustments or based on activity such as new user transactions, new Marketplace Information, and/or based on Saving System 200 Modification Suggestions.

In certain embodiments, the deposit into the Savings Account is made automatically according to the Savings Rule (e.g., Purchase Price Saving Percentage). The Savings Rule can be static or dynamic, where it adjusts based on events. For example, if the user is projected to reach the Savings Goal before the Target Date, then the user can reduce the savings percentage from 10% to 5% for duration (or pause all savings for a period of time, such as 2 weeks) of a Savings Period based on Saving System 200 automation or Saving System 200 guidance. In addition, a user may “boost” the Savings Account balance by depositing a certain dollar amount (e.g., $500) separate from the Savings Rule to the Savings Account, e.g., allowing user to achieve Savings Goal sooner.

The Savings Rule may be tied to any number of factors or conditions. For example, in one embodiment, the Savings Rule may be designed to deposit a certain percentage of spending (hereinafter, “Purchase Price Saving Percentage” rule”) into the Savings Account if certain conditions are met.

As discussed below, the factors or conditions discussed herein could be determined, confirmed, or otherwise accomplished by the Saving System 200 and the necessary information (e.g. transaction or balance data), could be obtained as discussed above or as further discussed below.

With a Purchase Price Saving Percentage rule, the Saving Rule may include one or more of the following: spending location (e.g., purchase location or purchased good/service location), the conditions under which an amount is to be saved, conditions under which savings should be reduced or stopped, amount to be saved, from where the savings is to be withdrawn, and to where the deposit is to be sent/saved.

As discussed below, the Savings System 200 may implement a process for automatically modifying and/or suggesting Savings Rules changes based on algorithms and/or Artificial Intelligence.

In one embodiment, the Saving Rule may include automated savings whenever a user makes a purchase from a certain store or for a category of products. In such a circumstance, for example, the user may instruct the Savings System 200 to automatically deposit a value equal to a certain percentage of all transactions made at a specific store (e.g., Amazon), for a specific product (e.g., gas), and/or for a specific category (e.g., groceries) into the Savings Account from the Funding Source.

As discussed above, the Saving System 200 may also be configured to include multiple Savings Goals. In this embodiment, the Saving System 200 may include multiple Savings Goals and/or multiple Savings Rules. This configuration can be applied along with any of the rules and goals discussed herein.

In another embodiment, or in combination with other rules, the Savings Rule may be based on when transactions are made from a certain account. For example, the Savings Rule may be configured to deposit a value equal to a certain percentage of all transactions made from a specific account (e.g., credit card X) or when payments are made from a specific account (e.g., paying off credit card from checking account Y).

In certain embodiments the Savings Rules may also include conditions which must be satisfied for the savings to be actuated. For example, the conditions could include minimum or maximum transaction amounts based on the above discussed rule factors. So, the user may set a rule to only make deposits on transactions of a certain value range. This could also include not acting on transactions below and/or above certain values.

Alternatively, or in combination, the Savings Rule may also include restrictions which must be satisfied before the saving contribution is made. In certain embodiments, the conditions may include minimum or maximum values in the Funding Source or Savings Account. For example, the user may require the system to determine that there is a minimum amount of value in the Funding Source account before withdrawing the deposit amount such as to avoid overdrafts. That minimum value could be designated as a minimum balance or related to a percentage or comparison to the underlying transaction [s] from the Savings Rule.

Such conditions may also be set by the Saving System 200. The Saving System 200 may be configured to confirm that there is a sufficient balance in the Funding Source prior to enacting the savings.

Alternatively, or in combination, the user may also designate a maximum savings account value. So, for example, once the Savings Account reaches a maximum value such as the Savings Goal, no more deposits or lesser/fewer deposits are made into the Savings Account. This could be tied to, for example, a dynamic Purchase Price Saving Percentage rule.

This restriction could also be based on time or transaction numbers. For example, the user may designate that a maximum number of savings deposits over a certain time period (e.g., 10 deposits per month).

In certain embodiments, the user may set rules or conditions for when to enact the savings deposits. For example, the user may designate that the transactions are only to be considered by the savings rule after a certain period of time (e.g. 7 days). In such a case, the user can change the rules or conditions after making a purchase but before the savings deposit is made. Alternatively, it would establish an opportunity during which the user could return a purchase and thereby exclude it from the savings.

Once the Savings Goal and Savings Rule are set, the Saving System 200 is configured to enact the Savings Plan.

In the case of a spend as you save rule, as shown in S102, the Savings System 200 monitors the spending according to the Saving Rule. The means of monitoring the spending depend on the specifics of the Saving Rule.

For example, in a simple Purchase Price Saving Percentage rule where the rule is to save a set percentage of total spending, the Saving System can obtain the user transaction history and then enable the savings (per any other factors or conditions).

This can be accomplished, for example by accessing the online portal available from the financial service utilized by the user for the Savings Rule (for example using the user's credentials or via special application programming interface (“API”)) or otherwise obtaining the transaction details.

In certain embodiments, this can be performed on set time intervals, such as when a user receives a monthly statement or pays a monthly credit card bill. One advantage is that this will reduce the amount of processing required for obtaining the data at more frequent intervals. The user could, for example, upload the credit card statement or the Savings System could obtain the necessary details (such as total credit card bill) from the financial institution from where the user pays the credit card bill. Alternatively, the user could manually upload the necessary transaction data and/or totals.

In the embodiments where the Saving System 200 automatically obtains the transaction data, this can be accomplished directly by the Saving System 200 and/or by third parties with existing financial institution interfaces or other accessibility. This can occur, for example, on set intervals or whenever new transactions are posted.

Once the Saving System 200 determines that a Savings Rule has been satisfied, the system determines whether other factors or conditions to enable savings are present S103. S103 may also be performed in parallel and/or simultaneously with S102. The means of determining whether the other factors or conditions are met depend on the specifics of the saving rule.

For example, in the case where the other factors include maximum or minimum balances, the Saving System 200 can obtain this information in similar ways as discussed above for S102.

After the Saving System 200 determines that all Savings Rule factors and conditions are met, the Saving System 200 withdraws the savings amount from the Funding Source and deposits it into the Savings Account S104.

The Saving System 200 may also comprise a Marketplace 212 configured to enable users to purchase objects from connected checking account/debit card or with their Savings Account. As discussed below, the Saving System 200 can also object information form the Marketplace 212 (“Marketplace Information”) which may include information from Marketplace Partners 214 regarding Saving Targets as well as information on other users which may be used in various algorithms and methods described herein.

According to one embodiment, a user obtains rewards (e.g., cash back, discount, etc.) if making a qualifying purchase, for example by completing a purchase from a Marketplace Partner 214 by utilizing user's connected Funding Source. For example, the user completes the purchase like normal either directly from their Funding Source of from their Savings Account and earns a marketplace reward (e.g. cash back) which can be directed to a Savings Goal.

In another embodiment, when a user purchases a product, service, or experience in the Marketplace 212, a certain percentage of the purchase is deposited into their Savings Account, which gives the user a boost to their Savings Account for future purchase(s).

Marketplace 212 purchases may also include Savings System 200 offers and awards such as cash back on certain purchases made in the Marketplace 212 or with Marketplace Partners 214.

Marketplace 212 purchases can be made either directly from the Savings Account or from other accounts tied to the user.

Data from the Marketplace 212 may also be utilized by the Saving System 200 (e.g., AI engine) to suggest modifications to Savings Rules and Savings Goals as discussed above. For example, Savings Goals can be suggested to users based on Marketplace Partner offerings. This can also be used based on the various data points discussed above.

Conversely, user Savings Goals described above may also be in conjunction with the Marketplace 212. For example, based on the user Savings Goals (e.g. a new car or vacation), specific Marketplace 212 offers can be directed to the user.

In certain embodiments, the Savings System 200 may be enacted by a Server 204 and/or physical components. As depicted in FIG. 2, the Savings System 200 may include various components.

For example, the Savings System 200 may include a user with a User Device 202 which connects to a network 216, server 204, and financial institutions such as Savings Bank 206 (e.g., Savings Account), Checking Bank 208 (e.g., Funding Source), Credit Card Bank 210, Marketplace 212, and Marketplace Partners 214.

The Savings System 200 is described in a context of computer-executable instructions, such as program modules, being executed by server computers, such as the Server 204. The Server 204 may operate a saving application. The User Device 202 may execute the saving application. The saving application may include programs, objects, components, data structures, etc., which may present features and functions as discussed above with regard to FIG. 1. The features of the Savings System 200 may be practiced either in a single computing device, or in a distributed computing environment, where the tasks are performed by processing devices, such as the User Device 202, which is linked through the Network 216. In a distributed computing environment, the various program modules may be located in both local and remote computer storage media including memory storage devices.

The Savings System 200 may operate in a cloud-computing environment where the User Device 202 operated by the user may be cloud-optimized. The User Device 202 may execute the saving application, and the user may access the tasks via the saving application. A remote cloud-based Server 204 may store and execute data and application programs associated with the saving application and the User Device 202. In the cloud-computing environment, a web browser on the User Device 202 may interface with an application program corresponding to the saving application. Utilizing the web browser executing on the User Device 202, the user may access the tasks. The User Device 202 may execute the tasks. The remote cloud-based Server 204 may receive the results (for example, confirming saving rule and/or conditions are satisfied.)

The User Device 202 is a portable or a non-portable computing device that performs operations according to programming instructions. The User Device 202 may execute algorithms or computer executable program instructions. A single processor or multiple processors in a distributed configuration of the User Device 202 may execute the algorithms or the computer executable program instructions. The User Device 202 may interact with one or more software modules of a same or a different type operating within the Savings System 200.

The User Device 202 may include a processor or a microprocessor for performing computations for carrying the functions of the User Device 202. Non-limiting examples of the processor may include, but not limited to, a microprocessor, an application specific integrated circuit, and a field programmable object array, among others. The processor may include a graphics processing unit specialized for rendering and generating computer-generated graphics. Non-limiting examples of the user device 202 may include, but are not limited to, a cellular phone, a tablet computer, a head-mounted display, smart glasses, wearable computer glasses, a personal data assistant, a virtual reality device, an augmented reality device, or a personal computer.

The User Device 202 may include an operating system for managing various resources of the User Device 202. An application-programming interface (API) associated with the operating system may allow various application programs to access various services offered by the operating system.

The User Device 202 may include the saving application, which may be a mobile application. The saving application may be installed, integrated, or operatively associated with the User Device 202. The saving application may be configured to, at least one of, (1) communicate with one or more software applications, storage devices, or appliances to send and receive a variety of data; (2) collect, define, store, and analyze the data; (3) formulate one or more tasks for being performed on or trained from the data; (4) provide, execute, communicate, and/or assist in formulating one or more mathematical models for tasks related to collection, identification, manipulation, and/or presentation of the data; (5) display, print, or communicate the data; and (6) transfer the data to one or more networked computing devices. The data may include information associated with one or more functions (e.g. confirming savings rules are satisfied).

The User Device 202 may implement the saving application. The implementation of the saving application may be as a computer program product, stored in non-transitory storage medium, when executed on the processor of the User Device 202. The saving application may be a software stack running on the operating system of the User Device 202. The saving application may have a protocol layer and a user interface layer where each layer may be responsible for specific jobs and functions. The protocol layer may communicate with the operating system, and manages various connections of the User Device 202 over the Network 216. The protocol layer may communicate with the user interface layer.

The User Device 202 may include a web browser. The web browser may access and present a saving web application. The User Device 202 may execute the saving web application, and then allow the user to view the savings rules and information such as savings account balance and recent transactions using the saving web application.

The Server 204 may be a computing device comprising a processing unit. The processing unit may include a processor with a computer-readable medium, such as a random access memory (RAM) coupled to the processor. The Server 204 may be running algorithms or computer executable program instructions. A single processor or multiple processors in a distributed configuration of the Server 204 may execute the algorithms or the computer executable program instructions. The server 204 may interact with one or more software modules of a same or a different type operating within the Savings System 200. Non-limiting examples of the processor may include a microprocessor, an application specific integrated circuit, and a field programmable object array, among others. Non-limiting examples of the Server 204 may include a server computer, a workstation computer, a tablet device, and a mobile device (e.g., smartphone).

The Server 204 may obtain the registration information from the user, confirms the Savings Rule factors and conditions are satisfied, and/or enact the savings deposits pursuant to the Savings Rules. This may include, for example, obtaining transaction and/or balance information from the various financial institutions as well as withdrawing and depositing the saving amount as discussed above.

The Network 216 may include, but is not limited to, a private local area network, a public local area network, a wireless local area network, a metropolitan area network, a wide-area network, and Internet. The Network 216 may further include both wired and wireless communications, according to one or more standards, via one or more transport mediums. The communication over the Network 216 is in accordance with various communication protocols, such as a transmission control protocol and an internet protocol, a user datagram protocol, and an institute of electrical and electronics engineers communication protocols. The Network 216 may further include wireless communications, according to Bluetooth specification sets, or another standard or proprietary wireless communication protocol. The Network 216 may further include communications over a cellular network, including, for example, a global system for mobile communications, code division multiple access, and enhanced data for global evolution network.

The Credit Card Bank 210 could be any place where transaction information is used and is not limited to just credit card banks. For example, rather than a credit card bank, the transaction information could be from a debit card account, accounting application, e-commerce platform, or even cryptocurrency wallet.

As depicted in FIG. 2, the various components are connected via the Network 216.

In certain embodiments, the Server 204 may have direct access to the financial institutions through secure connections. For example, the Savings System may obtain special access using an API rather than, or in addition to, traditional online login credentials.

The access to the financial institution may also include special access restrictions to further increase the security of the system. For example, the access could be limited such that the Savings System 200 could only obtain the transaction/balance date but not make any changes (e.g., read only). This would be useful for confirming that the savings rules and conditions are satisfied while limiting the release of credentials and/or other access to accounts that might be subject to security concerns. Thus, if a bad actor such as a hacker obtained the information with limited access, it could not perform any transactions.

This could be accomplished using traditional login credentials configured to limit access to read only which would prevent the Savings System 200 from making any changes or this could be implemented via the API or other means.

This access may also be limited to specific times, frequencies, or automatically obtained. For example, depending on the configuration, the system may automatically obtain all of the transaction data for a given period (e.g., 1 day) at a certain frequency (e.g., once per day). This could be configured to a specific time of day.

Alternatively, or in combination, the access may be limited to certain time periods. For example, access to certain financial institutions could be limited to certain times of day. This could be beneficial, for example, for limiting access to certain windows for security monitoring or to avoid high traffic windows.

The Savings System 200 may also include Saving Rule and/or Saving Goal suggestions, modifications, or replacements based on various data points. These may be based on data points from a specific user's trends and/or macro date for a plurality of users (both users of the Savings System or obtained externally) and may be developed using analytics, machine learning (e.g. artificial intelligence), and/or based on analysis/considerations manually entered into the saving system.

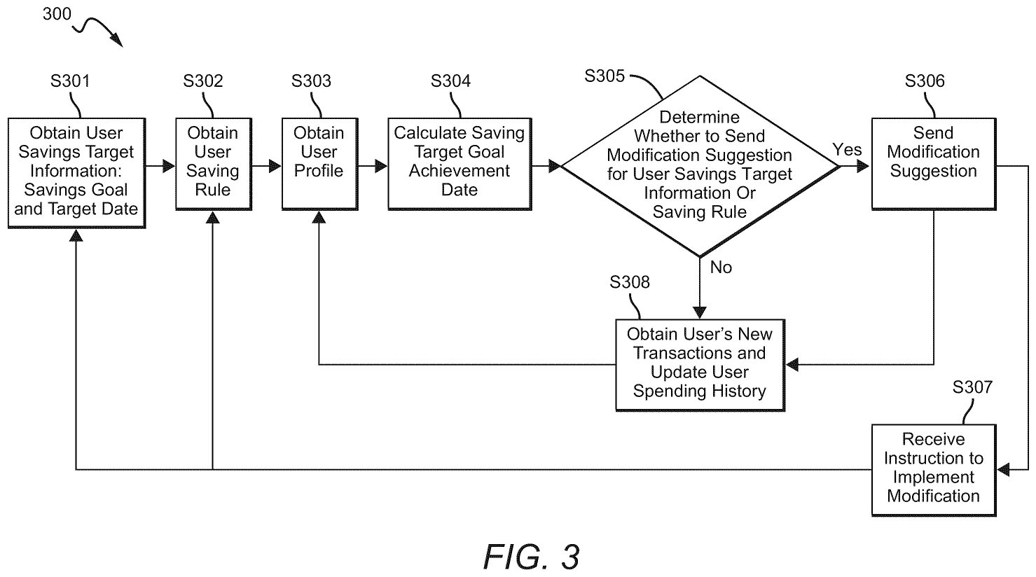

FIG. 3 depicts a flow chart of an intelligent saving system according to an embodiment of the disclosure. While FIG. 3 includes various steps in a certain order, it is understood that certain of these steps may not be required, that the order of steps may change, and/or that other intervening steps may be utilized depending on the system and user requirements and desires. As discussed above, this process may be performed, for example, by a server configured per the Saving System.

At the outset, the Saving System 200 obtains User Target Saving Information such as User Saving Goal and Saving Target Date S301. As discussed above, this information could include, but is not limited to, a desired saving amount or purchase and a desired date to reach the Savings Goal.

As S302, the Saving System 200 obtains the User Saving Rule. For example, as discussed above, the Saving Rule may be a Purchase Price Saving Percentage (e.g., spend while you save) and may include various conditions and restrictions. In certain embodiments, the Saving Rule information may be included in the Savings Target Information and therefore Steps S301 and S302 may be combined.

The Saving System 200 then obtains the User Profile at S303 which at least comprises the user Spending History. The Spending History may comprise a history of the user's spending over time, such as average monthly spend or may also include spending patterns, such as spending trends, recent or seasonal.

Depending on the Saving System 200, the Spending History may be set amounts per month, averaged or by time period (e.g. each month), may be estimated by an equation, and/or may be a based on an AI model. Any of the models may be fixed numbers or may be updated based on new information, in real time or at intervals.

The User Profile may also include various user data such as past activity and region, and may also information for the user based on anonymized and aggregated data obtained and analyzed for other comparable users. For example, this may include spending habits by comparable users based on certain times of year, spending by age (e.g., at age 26 users may increase travel spending over the previous year), or other information. This may also include Marketplace information such as trends of comparable users to buy devices after new releases.

The Spending History may also be determined by an Artificial Intelligence model user either only the individual user's information, the aggregated data, and/or may also include data from the Marketplace based on past and projected purchases.

The Saving System 200 then uses the User Profile, such as the Spending History, and the Saving Rule to calculate a Saving Target Goal Achievement Date S304.

For example, in an embodiment with a Purchase Price Saving Percentage rule, the Saving System 200 may multiply the saving percentage and the average spend history (daily, weekly, monthly, etc.) of the user to determine whether then user will achieve the Savings Goal based on the current spending rates.

In certain embodiments, however, this step may not be necessary and the Saving System 200 may not update any of the Saving Information or Saving Rule, or may suggest modifications based on other factors.

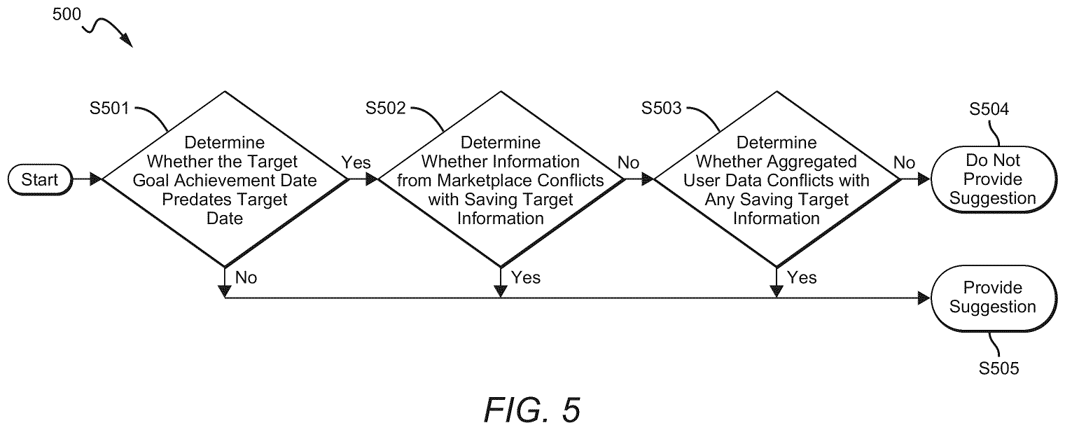

Subsequently, the Saving System 200 determines whether to send a Modification Suggestion for user Savings Target Information or Saving Rule at S305. As discussed below with regard to FIG. 5, this determination may be based on a variety of factors.

The Modification Suggestion itself could take various forms. For example, the Modification Suggestion could be to adjust the Saving Rule such as by increasing the Purchase Price Saving Percentage or removing or adjusting saving conditions or restrictions such as removing saving caps or including otherwise excluding transaction to the Saving Rule. The Modification Suggestion could also be to adjust the Savings Target Date or the Savings Goal and to maintain the current Saving Rule.

In the above discussed embodiment utilizing a Purchase Price Saving Percentage rule, the Saving System 200 may determine to send a modification to the user if the calculated Saving Target Goal Achievement Date is after the Savings Target date.

The Saving System 200 may also suggest Savings Rule modifications based on a user's spending habits. These modifications may be based, for example, on an artificial intelligence model and/or that focuses on saving more for non-essential purchases. For example, the Saving System 200 could suggest a small saving percentage based on purchases made for necessities such as groceries or gasoline or a larger percentage based on purchases made for luxuries such as video games. This could be based on user-specific data. For example, if a user is spending a certain percentage of total monthly spend on a certain good or at a certain store, the Saving System 200 may suggest modifying the Saving Rule. This may also be useful in budgeting and/or curbing undesirable spending habits.

These suggestions may also be made based on external data. For example, if a user has a Savings Goal related to a travel experience, the Savings System 200 may suggest altering the Savings Rule or Savings Goal to achieve the goal by a certain date based on projected travel costs. For instance, if plane tickets to a certain destination are projected to be at the lowest point at a certain time of year, the Saving System could suggest modifying the Savings Rules to account for these changes.

For example, the Savings System 200 may suggest modifications to the Savings Rule or Savings Goal based on input received from Marketplace Partners 214, e.g., promotions or “intercept.” Intercepts, for example, allow a competing Marketplace Partner 214 to “intercept” a competitor's potential sale with an advertisement, digital gift, special offer, e.g., Porsche promotes its vehicle to user with Savings Goal targeted at Range Rover. For example, a Merchandise Partner 214 may utilize the System 200 to create advertising campaigns at the point of purchase, while measuring the effectiveness of these campaigns by analyzing conversions and impressions.

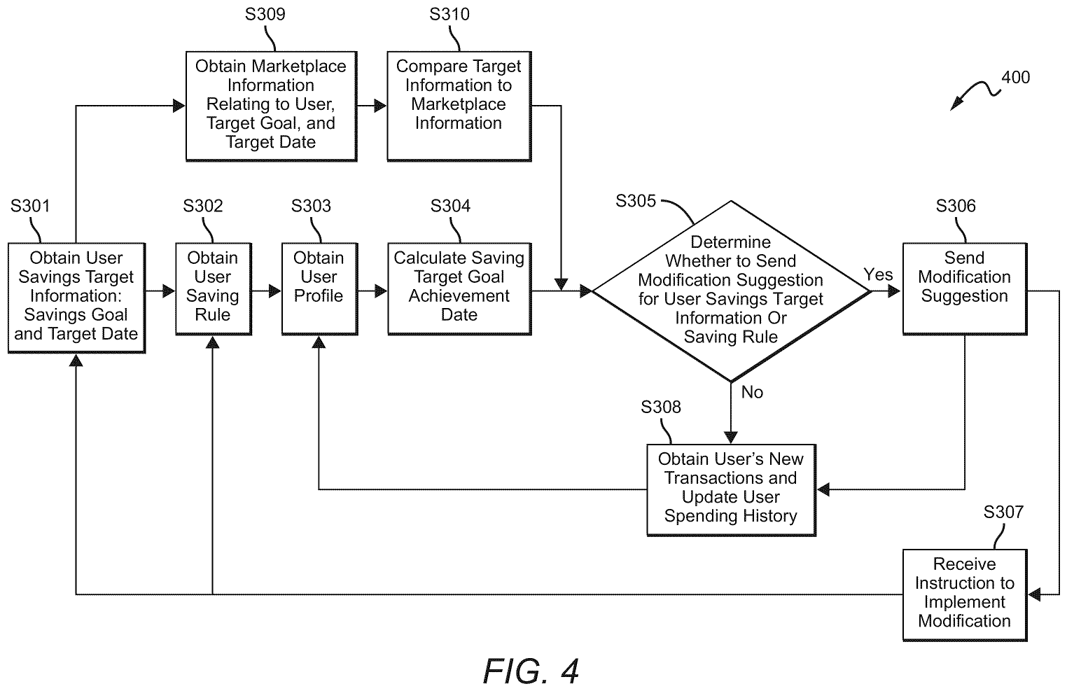

Similarly, and as shown for example in FIG. 4, if a user has set a Savings Goal for a certain Saving Target (e.g., a specific car model or cell phone), the Saving System may obtain information from the marketplace indicating that a new model may be issuing and/or that a price break or sale is occurring and suggest a modification to the user. As shown at S309, the Saving System obtains Marketplace Data relating to the user and Target Information such as Target Goal and Target Date.

Subsequently, at S310, the Saving System 200 can compare this Marketplace Data to the Target Information which can be used, as discussed above, to make the determination whether to suggest a modification.

Alternatively, the system may make suggestions based on macro user data and/or machine learning. For example, if a portion of users of a specific demographic (e.g. geography, age, household income) are making certain purchases or have related Savings Goals, the Saving System may suggest various modifications.

If the Saving System 200 determines to send a Modification Suggestion at S305, the Saving System sends the Modification Suggestion to the user at S306.

It is understood, however, that in certain embodiments the system may also be configured top automatically make the adjustment depending on system requirements and/or user settings.

For example, in certain configurations, the user can set certain restrictions and/or conditions similar to those discussed above with regard to the Saving Rules for when the Saving System can make modifications and/or to what extent the Saving System can automatically make modifications. The conditions could include minimum/maximum balances in the Savings Account or Funding Source. Alternatively, the restrictions could include a minimum or maximum change amount, such as allowing automatic Saving Rule percentage changes if they are within a threshold (e.g., 5%).

Then, optionally after receives an instruction to implement the modification, the Saving System implements the modification at S307. Subsequently, the Saving System 200 updates the Saving Target Information and/or Saving Rule and the process repeats.

Meanwhile, if the Saving System 200 determines not to send a Modification Suggestion or after sending the Modification Suggestion, the Saving System 200 obtains new user transactions and updates the User Profile at S308.

The new user transactions could be obtained based on predetermined scheduling (e.g., once per day), as requested by the user, or could be updated whenever new transactions are identified. For example, if the Saving System 200 is constantly scouring the user's accounts as discussed above, then the updates could occur in real time.

It is understood that the Saving System 200, for example as depicted in FIG. 3, can constantly be updating based on any changes to Saving Information, Saving Rules, and/or changes to the User Profile including changes to the Spending History based on new transactions or changes based on aggregated data of other users of Marketplace Information.

These updates can be triggered in numerous ways including on a predetermined schedule, whenever new inform is obtained, or directly triggered by users.

FIG. 5 depicts a flow chart of the logic for a determination whether to suggest a saving modification according to an embodiment of the disclosure. While FIG. 5 includes various steps in a certain order, it is understood that certain of these steps may not be required, that the order of steps may change, and/or that other intervening steps may be utilized depending on the system and user requirements and desires.

As discussed above with regard to FIG. 3, the Saving System 200 can utilize numerous factors when determining whether to suggest a modification to the Saving Information and/or Savings Rules. As discussed above, this process may be performed, for example, by a server configured per the Saving System 200.

For example, as shown at S501, the Saving System 200 can determine whether the Target Goal Achievement Date Predates the Target Date. As discussed above, the Saving System 200 can calculate the Target Goal Achievement Date in various ways including, for example, by multiplying the save percentage by a projected spending rate based on the user profile.

In certain embodiments, if the Target Goal Achievement Date does not predate the Target Date (e.g., user savings are not projected to achieve Savings Goal by the Target Date), the system would proceed to S505 and suggest a modification.

Conversely, if the Target Goal Achievement Date predates the Target Date, then the Saving System 200 would consider another factor when determining whether to suggest a modification.

As shown in S502, the Saving System 200 would also consider whether any Marketplace Information conflicts with the Savings Goal or Target Date.

This step could include simple comparisons on product release dates as compared to Target Dates, purchase prices compared to Savings Goal, or even various Artificial Intelligence models based on comparison and information of purchase targets similar to the Savings Goals.

If there is a conflict between the Marketplace Information and the Saving Target Information, the system would proceed to S505 and suggest a modification.

If there is no conflict between the Marketplace Information and the Saving Target Information, then the Saving System 200 would consider another factor when determining whether to suggest a modification.

As shown in S503, the Saving System 200 could also be configured to consider whether Aggregated User Data conflicts with any Saving Target Information. As discussed above, the Saving System 200 can consider activity by other user with similar user profiles or other information. For example, if similar users Saving Rules were different than the user Saving Rule, the system may suggest a modification.

This step could also be combined with the analysis from S502. For example, if similar users are making certain purchases in the Marketplace which are not set forth in the Target Goals, they may be suggested as a modification to the Savings Goal.

If there is a conflict between the Aggregated User Data and the Saving Target Information, the system would proceed to S505 and suggest a modification.

If there is no conflict between the Aggregated User Data and the Saving Target Information, then the Saving System 200 would consider another factor when determining whether to suggest a modification. If there were no other factors, the system would proceed to S504 and not suggest a modification.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the methods and embodiments described herein. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc, laser disc, optical disc, digital versatile disc, floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present subject matter. Various modifications to these embodiments will be readily apparent to those skilled in the art, and the generic principles defined herein may be applied to other embodiments without departing from the spirit or scope of the subject matter. Thus, the present subject matter is not intended to be limited to the embodiments shown herein but is to be accorded the widest scope consistent with the following claims and the principles and novel features disclosed herein. While various aspects and embodiments have been disclosed, other aspects and embodiments are contemplated. The various aspects and embodiments disclosed are for purposes of illustration and are not intended to be limiting, with the true scope and spirit being indicated by the following claims.

We claim:

1. A financial institution agnostic saving system comprising:
a server configured to:
receive information for a funding source of a user at a first financial institution;
receive information for a saving account of the user at a second financial institution;
receive user saving target information for the user wherein the user saving target information comprises:
a saving rule for determining when to transfer funds from the funding source to the saving account wherein the saving rule is defined based on an amount spent by the user;
receive transaction information for a transaction by the user from a third financial institution, wherein the transaction information includes the amount spent by the user; and
transfer money from the funding source to the saving account according to the saving rule based on the transaction information.

2. The financial institution agnostic saving system according to claim 1,
wherein the server is further configured to determine whether to suggest a modification to the user saving target information.

3. The financial institution agnostic saving system according to claim 1,
wherein the user saving target information comprises a savings goal and a target date, and
wherein the server is configured to:
generate a user profile of the user wherein the user profile comprises a spending history;
calculate a target goal achievement date based on the savings goal, the savings rule, and the user profile; and
determine whether to suggest a modification to the user saving target information based on the target goal achievement date.

4. The financial institution agnostic saving system according to claim 3,
wherein if the target date predates the target goal achievement date, the server is configured to modify the saving rule such that, based on the spending history, the user will achieve the saving goal on or before the target date.

5. The financial institution agnostic saving system according to claim 1,
wherein the saving system comprises a marketplace;
wherein the server is configured to
obtain marketplace information from the marketplace;
determine whether to suggest a modification to the user saving target information based on the marketplace information.

6. The financial institution agnostic saving system according to claim 5,
wherein the marketplace information comprises information relating to user saving target information of other users.

7. The financial institution agnostic saving system according to claim 5,
wherein the saving target information comprises a savings goal; and
wherein the marketplace information comprises information related to the saving goal.

8. The financial institution agnostic saving system according to claim 5,
wherein the saving target information further comprises a target date; and
wherein the marketplace information comprises information relating to the target date.

9. The financial institution agnostic saving system according to claim 3,
wherein the server is configured to implement the suggested modification.

10. The financial institution agnostic saving system according to claim 9,
wherein the server is configured to update the saving target information after implementing the modification.

11. The financial institution agnostic saving system according to claim 3,
wherein the server is configured obtain new transaction information and update the user profile after determining whether to suggest the modification.

12. The financial institution agnostic saving system according to claim 11,
wherein the server is configured determine whether to send a modification suggestion after updating the user profile.

13. The financial institution agnostic saving system according to claim 10,
wherein the server is configured determine whether to send a modification suggestion after updating the saving target information.

14. The financial institution agnostic saving system according to claim 3,
wherein the determination is based on the target goal achievement date, aggregated user data, and marketplace information.

15. The financial institution agnostic saving system according to claim 3,
wherein the suggested modification is based on an artificial intelligence model utilizing the user profile and aggregated user data based on activity of other users.

16. The financial institution agnostic saving system according to claim 3,
wherein the suggested modification is based on an artificial intelligence model utilizing the user profile and marketplace information.

17. The financial institution agnostic saving system according to claim 3,
wherein the user profile is generated using an artificial intelligence model utilizing the user profile and aggregated user data based on activity of other users.

18. The financial institution agnostic saving system according to claim 1,
wherein the saving system further comprises a marketplace;
wherein the server is configured to:
generate a user profile of the user wherein the user profile comprises a spending history;
calculate a target goal achievement date based on the savings goal, the savings rule, and the user profile;
obtain marketplace information from the marketplace, wherein the marketplace information comprises information relating to activity of other users; information relating to the saving goal; and information relating to the target date;
determine whether to suggest a modification to the user saving target information based on the marketplace information, target goal achievement date, and aggregated user data;
update the saving target information after implementing the modification;
obtain new transaction information and update the user profile after determining whether to suggest the modification;
determine whether to send a modification suggestion after updating the user profile;
determine whether to send a modification suggestion after updating the saving target information;
wherein the suggested modification is based on an artificial intelligence model utilizing the user profile and aggregated user data based on activity of other users, the user profile, and marketplace information;
wherein the user profile is generated using an artificial intelligence model utilizing the user profile and aggregated user data based on activity of other users; and
wherein the server is configured to transfer money from the funding source to the saving account according to the saving rule based on the transaction information only if a condition of the transaction amount and a restriction on the minimum amount in the funding source are met.

19. A financial institution agnostic saving method comprising:
receiving information for a funding source of a user at a first financial institution;
receiving information for a saving account of the user at a second financial institution;
receiving user saving target information for the user wherein the user saving target information comprises:
a saving rule for determining when to transfer funds from the funding source to the saving account wherein the saving rule is defined based on an amount spent by the user;
receiving transaction information for a transaction by the user from a third financial institution, wherein the transaction information includes the amount spent by the user; and
transferring money from the funding source to the saving account according to the saving rule based on the transaction information.

20. A non-transitory computer readable storage medium storing a plurality of instructions, wherein when executed by at least one processor, the plurality of instructions cause a computer to:
receive information for a funding source of a user at a first financial institution;
receive information for a saving account of the user at a second financial institution;
receive user saving target information for the user wherein the user saving target information comprises:
a saving rule for determining when to transfer funds from the funding source to the saving account wherein the saving rule is defined based on an amount spent by the user;
receive transaction information for a transaction by the user from a third financial institution, wherein the transaction information includes the amount spent by the user; and
transfer money from the funding source to the saving account according to the saving rule based on the transaction information.
